(19) United States
(12) Patent Application Publication
(10) Pub. No.: US 2024/0289831 A1
(43) Pub. Date: Aug. 29, 2024

(54) System and method specifically tailored for the inclusion and sharing of short-form video within referral marketing

(71) Applicant: Curebit, Inc., San Francisco, CA (US)

(72) Inventors: Allan Grant, Davie, FL (US); Alexander Sienkiewicz, San Francisco, CA (US); Sara Cook, St. Louis, MO (US); Olexander Bondar, Kyiv (UA); Bohdan Zhuravel, Kyiv (UA); Maxim Dzhulii, Kyiv (UA); Hanna Rosul, Kyiv (UA); Illia Khvesevych, Kyiv (UA); Vitalii Oliinyk, Kyiv (UA); Lillia Hnybida, Mykolaiv (UA); Enver Ablyaev, Kyiv (UA); Valeriia Kuzmina, Kyiv (UA)

(73) Assignee: Curebit, Inc., San Francisco, CA (US)

(21) Appl. No.: 18/520,382

(22) Filed: Nov. 27, 2023

Related U.S. Application Data
(60) Provisional application No. 63/428,082, filed on Nov. 27, 2022.

(51) Int. Cl. G06Q 30/0214; H04N 5/76

(52) U.S. Cl. CPC G06Q 30/0214; H04N 5/76

(57) ABSTRACT

A system tailored for the inclusion and sharing of short-form video within referral marketing. The system starts when an Advocate sees a referral campaign and a share screen is displayed to the Advocate. The Advocate is able to record a video or attach a video. Video attachment happens by adding a video from advocate's mobile or desktop device. Advocate recording is seamless on mobile or desktop devices. The Advocate is able to record up to 1 minute, replay the video, re-record video, and select the recorded video for usage in the campaign. The Advocate is able to preview the video again and the Advocate is able to delete the video. When an Advocate shares a video, the video is attached to the campaign page. An animated GIF having a URL link to the campaign page is shared by server side email, native email applications, link sharing, messaging, and iMessaging.

### FEDERALLY SPONSORED RESEARCH

Not Applicable

### SEQUENCE LISTING OR PROGRAM

Not Applicable

### TECHNICAL FIELD OF THE INVENTION

The present invention relates generally to referral marketing. More specifically, the present invention relates to a system and method specifically tailored for the inclusion and sharing of short-form video within referral marketing

### BACKGROUND OF THE INVENTION

Referral marketing is an organized process where a business is able to reward customers for sharing the brand or products with friends, family, and colleagues. Different to pure word-of-mouth strategies which are primarily customer directed with the company unable to track, influence and measure message content; referral marketing encourages and rewards the referrer for allowing a company to do so. Digitally enabled referral marketing has become a popular customer acquisition channel for marketers as this channel provides a relatively lower new customer acquisition cost versus other typical marketing channels.

While referral marketing continues to gain in popularity, the functions for making referrals have largely been unchanged since its inception for e-commerce and other digitally enabled services; that is, an advocate is able to share their referral link or code though mediums such as Email, SMS, Social Media, or a Sharable Link (for other messaging channels), which is always communicated through a text based function.

In recent years, short-form user generated content (UGC) video has become a popular digital medium in society due to several factors: 1. Social media platforms are adopting this medium as the primary content to be shared. 2. Millennials and Gen-Z generations have become more accustomed to creating this type of content. 3. The Pandemic has accelerated societal adoption of video sharing (e.g., Facetime and Zoom) 4. Mobile and Desktop devices continue to get more advanced with high quality and sophisticated camera recording features and functionality.

The objective of the present invention is to provide the system and method to allow referrals to be made which allow the inclusion of short-form UGC videos and the sharing of them through the mediums previously mentioned: Email, SMS, Social Media, or a Sharable Link. Each referral channel has its own technical intricacies to allow for the inclusion of visually enabled video, which this present invention covers.

For instance, for email referral sharing, videos cannot be rendered in their native format embedded in the email, so a looping animated GIF is required to render a portion of the video. For iOS iMessage SMS referral sharing, there are specific size requirements (per the Open Graph Protocol) to enable automatic video previewing in the message thread.

The belief is that the inclusion of an authentic and personable video testimonial about the brand or product in peer-to-peer sharing will allow for better referral marketing performance. In addition, the UGC video content created by advocates can later be analyzed and used by the brand for other marketing purposes.

### Definitions

Unless stated to the contrary, for the purposes of the present disclosure, the following terms shall have the following definitions:

Administrators, commonly known as admins or sysops (system operators), are software or system users who have been granted the technical ability to perform certain special actions.

“Application software” is a set of one or more programs designed to carry out operations for a specific application. Application software cannot run on itself but is dependent on system software to execute. Examples of application software include MS Word, MS Excel, a console game, a library management system, a spreadsheet system etc. The term is used to distinguish such software from another type of computer program referred to as system software, which manages and integrates a computer's capabilities but does not directly perform tasks that benefit the user. The system software serves the application, which in turn serves the user.

“API” In computer programming, an application programming interface (API) is a set of routines, protocols, and tools for building software applications. An API expresses a software component in terms of its operations, inputs, outputs, and underlying types. An API defines functionalities that are independent of their respective implementations, which allows definitions and implementations to vary without compromising each other.

A client is a piece of computer hardware or software that accesses a service made available by a server. The server is often (but not always) on another computer system, in which case the client accesses the service by way of a network. The term applies to programs or devices that are part of a client-server model.

“Electronic Mobile Device” is defined as any computer, phone, smartphone, tablet, or computing device that is comprised of a battery, display, circuit board, and processor that is capable of processing or executing software. Examples of electronic mobile devices are smartphones, laptop computers, and table PCs.

A gateway is a link between two computer programs or systems such as Internet Forums. A gateway acts as a portal between two programs allowing them to share information by communicating between protocols on a computer or between dissimilar computers.

“GUI”. In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard.

The Hypertext Transfer Protocol (HTTP) is an application protocol for distributed, collaborative, hypermedia information systems. HTTP is the foundation of data communication for the World Wide Web. Hypertext is structured text that uses logical links (hyperlinks) between nodes containing text. HTTP is the protocol to exchange or transfer hypertext.

The Internet Protocol (IP) is the principal communications protocol in the Internet protocol suite for relaying datagrams across network boundaries. Its routing function enables internetworking, and essentially establishes the Internet.

An Internet Protocol address (IP address) is a numerical label assigned to each device (e.g., computer, printer) participating in a computer network that uses the Internet Protocol for communication. An IP address serves two principal functions: host or network interface identification and location addressing.

An Internet service provider (ISP) is an organization that provides services for accessing, using, or participating on the Internet.

iOS (originally iPhone OS) is a mobile operating system created and developed by Apple Inc. and distributed exclusively for Apple hardware. It is the operating system that presently powers many of the company's mobile devices, including the iPhone, iPad, and iPod touch. Short for Multimedia Message Service, MMS is a messaging system capable of distributing text messages with graphics, sounds, and videos over WAP (Wireless Application Protocol). It is a texting standard that replaced SMS, which had a short limit of about 160 characters, and did not allow multimedia attachments.

Lifetime value (LTV) estimates how much revenue a customer represents a business over the life of that relationship. Also called customer lifetime value (CLV, or CLTV), this is a critical metric for a company trying to gauge the cost efficiency of acquiring new customers and supporting them over time.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “mobile device” is a generic term used to refer to a variety of devices that allow people to access data and information from wherever they are. This includes cell phones and other portable devices such as, but not limited to, PDAs, Pads, smartphones, and laptop computers.

A “module” in software is a part of a program. Programs are composed of one or more independently developed modules that are not combined until the program is linked. A single module can contain one or several routines or steps.

A “module” in hardware, is a self-contained component.

“Open Graph” or “Open Graph Protocol” is an internet protocol that was originally created by Facebook to standardize the use of metadata within a webpage to represent the content of a page. Within it, you can provide details as simple as the title of a page or as specific as the duration of a video. The Open Graph protocol enables any web page to become a rich object in a social graph.

An operating system (OS) is software that manages computer hardware and software resources and provides common services for computer programs. The operating system is an essential component of the system software in a computer system. Application programs usually require an operating system to function.

A server is a running instance of an application (software) capable of accepting requests from the client and giving responses accordingly. Servers can run on any computer including dedicated computers, which individually are also often referred to as “the server”. Short for short message service, SMS is a widely-accepted wireless service that allows individuals to send short text messages with wireless devices, such as mobile phones and pagers. See the text message definition for additional information and links related to this term.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used. A software module is defined as a series of process steps stored in an electronic memory of an electronic device and executed by the processor of an electronic device such as a computer, pad, smart phone, or other equivalent device known in the prior art.

A “software application module” is a program or group of programs designed for end users that contains one or more files that contain instructions to be executed by a computer or other equivalent device.

A “smartphone” (or smart phone) is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smartphones include all of those plus the features of a touchscreen computer, including web browsing, wideband network radio (e.g., LTE), Wi-Fi, 3rd-party apps, motion sensor and mobile payment.

A “smart dot” or “SD” is a vehicle transmitter that has the capability through a transmitter, or a variety of transmitters to broadcast the vehicle's speed, velocity, instantaneous velocity, angular velocity, acceleration, deceleration or other data that can be used to determine if a vehicle is in motion.

UGC is an abbreviation for user generated content.

URL is an abbreviation of Uniform Resource Locator (URL), it is the global address of documents and other resources on the World Wide Web (also referred to as the “Internet”).

A “User” is any person registered to use the computer system executing the method of the present invention.

In computing, a “user agent” or “useragent” is software (a software agent) that is acting on behalf of a user. For example, an email reader is a mail user agent, and in the Session Initiation Protocol (SIP), the term user agent refers to both end points of a communications session. In many cases, a user agent acts as a client in a network protocol used in communications within a client-server distributed computing system. In particular, the Hypertext Transfer Protocol (HTTP) identifies the client software originating the request, using a “User-Agent” header, even when the client is not operated by a user. The SIP protocol (based on HTTP) followed this usage.

A “web application” or “web app” is any application software that runs in a web browser and is created in a browser-supported programming language (such as the combination of JavaScript, HTML and CSS) and relies on a web browser to render the application.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site.

### SUMMARY OF THE INVENTION

The present invention is a system and method specifically tailored for the inclusion and sharing of short-form video within referral marketing. The system starts when an Advocate sees a referral campaign. If the Advocate is not signed up or registered, the Advocate would go through a signup process. Once or if the Advocate is signed up and logged in, a share screen is displayed to the Advocate.

Next the Advocate is presented with a screen to record a video and can proceed to record a video. The Advocate is able to record a video or attach a video. Video attachment happens by adding a video from advocate's mobile or desktop device.

Advocate recording is seamless on mobile or desktop devices. The Advocate is able to record up to 1 minute, replay the video, re-record video, and select the recorded video for usage in the referral campaign. Upon advocate's permission, video is attached to the referral campaign page. The Advocate is able to preview the video again and the Advocate is able to delete the video.

After the Advocate attaches the video file, the system compresses the video to save the video below 10 MB, creates and saves a higher resolution version for use as a claim page video, and converts the video to a three to five second three to five second animated GIF. The 10 MB threshold for saving a video is a constriction for iMessaging because of Apple's Open Graph Protocol.

The system further adds the video to a video library for staff use only. Staff can see all videos created and shared by an Advocate and can download shared videos and see Advocate's details such as name/surname, email, phone, referral impact, purchase history, customer lifetime value (LTV) and the screenshot/preview. Staff may perform a list of actions, add videos to favorites, archive videos, and delete videos or download them.

When an Advocate shares a video, it is shared by server side email, native email applications, link sharing, messaging, and iMessaging.

For server side email, the system attaches a three to five second animated GIF from the video to the email, which is then sent to one or more friends who receive an email with the three to five second animated GIF and link to the claim page. The friend plays the video on the claim page and in some instances the friend signs up.

For native email applications, the system passes the body of the email with a three to five second animated GIF and link to the claim page. The advocate sends an email to one or more friends who receive an email with the three to five second animated GIF and link to the claim page. The friend plays the video on the claim page and in some instances the friend signs up.

For link sharing, the Advocate copies the link and shares it with friends. The link URL includes meta data following the guidelines of the Open Graph Protocol, to maximize the chance the video is shown through the medium it is being shared on (e.g. WHAT'S APP, FACEBOOK MESSENGER). The friend receives the link and clicks on the URL in the animated GIF. The friend plays the video on the claim page and in some instances the friend signs up.

For messages, the system passes the animated GIF with a clickable URL to the video through SMS to another mobile device. The advocate sends a message, and the friend receives a message with the animated GIF with a clickable URL to the video and clicks on the URL in the animated GIF. The friend plays the video on the claims page and in some instances the friend signs up.

For iMessages, the system passes the animated GIF with a clickable URL to the video below 10 MB through SMS to another iOS device with iMessage enabled. The advocate sends an iMessage and the friend receives as iMessage with the animated GIF with a clickable URL to the video and clicks on the URL in the animated GIF. The friend plays the video on the claims page and in some instances the friend signs up.

### BRIEF DESCRIPTION OF THE DRAWINGS

The accompanying drawings, which are incorporated herein a form a part of the specification, illustrate the present invention and, together with the description, further serve to explain the principles of the invention and to enable a person skilled in the pertinent art to make and use the invention.

FIGS. 1-6 are illustrative screenshots of the user experience illustrating a first flow of the user experience and user interface for the referral sharing with video as taught by the present invention.

FIGS. 7-8 are illustrative screenshots of the user experience illustrating a second flow of the user experience and user interface for the referral sharing with video as taught by the present invention.

FIG. 9 is an illustrative screenshot of the user experience for uploading a previously created or recorded video for the referral sharing with video as taught by the present invention.

FIGS. 10A, 10B, 10C, and 10D is a master flow chart for the system and method specifically tailored for the inclusion and sharing of short-form video within referral marketing as taught by the present invention.

FIG. 11 is an illustrative screenshot of the user experience for server side email sharing with embedded three to five second animated GIF as taught by the present invention.

FIGS. 12A, 12B, and 12C is a flow chart of the user experience for server side email sharing with embedded three to five second animated GIF as taught by the present invention.

FIG. 13 is an illustrative screenshot of the user experience for native side email sharing with embedded three to five second animated GIF as taught by the present invention.

FIGS. 14A, 14B, and 14C is a flow chart of the user experience for native email sharing with embedded three to five second animated GIF as taught by the present invention.

FIG. 15 is an illustrative screenshot demonstrating embedded video in an iMessage as taught by the present invention.

FIGS. 16A, 16B, and 16C is a flow chart for the method of creating embedded video in an iMessage as taught by the present invention.

FIG. 17 is an illustrative screenshot demonstrating an embedded three to five second animated GIF file as taught by the present invention.

FIGS. 18A, 18B, and 18C is a flow chart for the method of creating an embedded three to five second animated GIF file as taught by the present invention.

FIG. 19 is an illustrative screenshot of the user experience for the end user dashboard as taught by the present invention.

FIGS. 20A, and 20B is a flow chart of the user experience for the end user dashboard as taught by the present invention.

FIG. 21 is a flowchart diagram for voice to text transcribing and analysis as taught by the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention is practiced. These embodiments are described in sufficient detail to enable those skilled in the art to practice the invention, but other embodiments are utilized, and logical, mechanical, electrical, and other changes is made without departing from the scope of the present invention. The following detailed description is, therefore, not to be taken in a limiting sense, and the scope of the present invention is defined only by the appended claims.

The present invention teaches a system and method specifically tailored for the inclusion and sharing of short-form video within referral marketing. To enable this functionality, an intuitive web interface is first needed to capture the recorded short-form UGC video from the advocate on the referral page.

With the advent of short-form UGC video as one of the most popular mediums for Marketing, brands are increasingly turning to the usage of this content for use in advertising. A recent study showed that 71% of Marketers plan on increasing efforts in video content.

An ancillary benefit of acquiring Short-Form UGC Video through referral marketing is twofold: It provides detailed information on who the advocate buyer personas are through visual analysis as well as a library of content which can be used for other purposes (with the consent of the advocate).

For instance, for email referral sharing, videos cannot be rendered in their native format embedded in the email, so a looping animated GIF is required to render a portion of the video. For iOS iMessage SMS referral sharing, there are specific size requirements (per the Open Graph Protocol) to enable automatic video previewing in the message thread.

To showcase this video content to the business owner/end-user, a dashboard portal must be created to showcase this content. Furthermore, using an internal transcribing framework, additional details about the content can be provided to the end-user. This includes: Highlighting specific keywords that would convey high advocacy such as “good, love, like, amazing, incredible”; and Measuring intonation level in speech for these specific keywords and other keywords to quantify the emotion level of the advocate. Intonation is the changing of tone in a person's voice when sounding out particular words. It often reflects emotion, emphasis and attitudes when speaking.

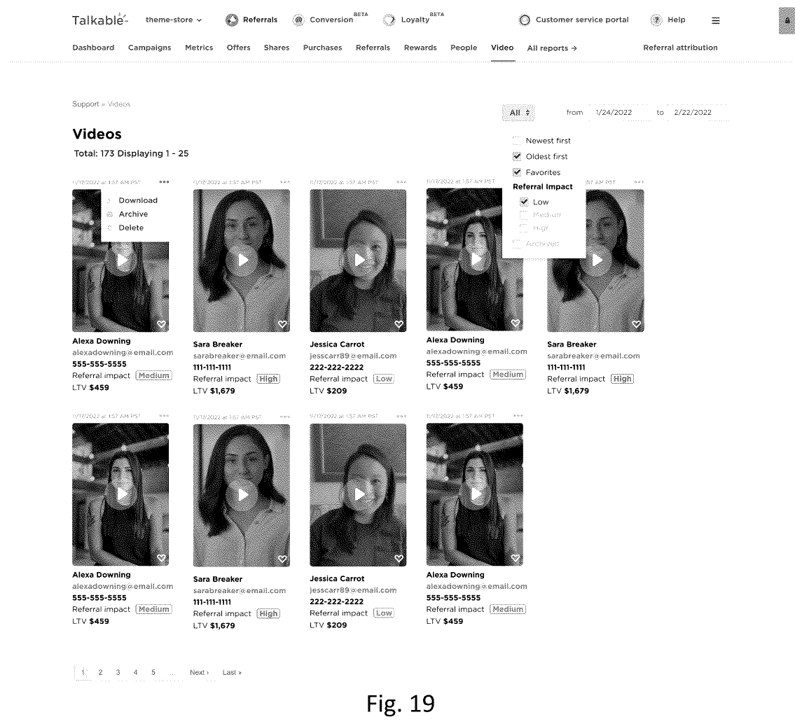

Within the dashboard as shown in FIG. 19, the end-user is able to: Play any previously recorded UGC Video; View specific details about the advocate such as purchase history, lifetime value (LTV), recent purchase details, location, name, email address; Visualization details on the speech transcription, along with a visual representation quantifying emotion-level and usage of specific keywords that are emphasized with a sentiment score; Provide the end-user with the ability to download the Video; Provide the end-user with the ability to favorite the Video; Provide the end-user with the ability to archive the Video; Provide the end-user with the ability to delete the Video; Newly created videos can also trigger an email notification to the end-user; and Provide the end-user with a mechanism to contact the advocate through email for various purposes such as requesting access to use the content for other purposes.

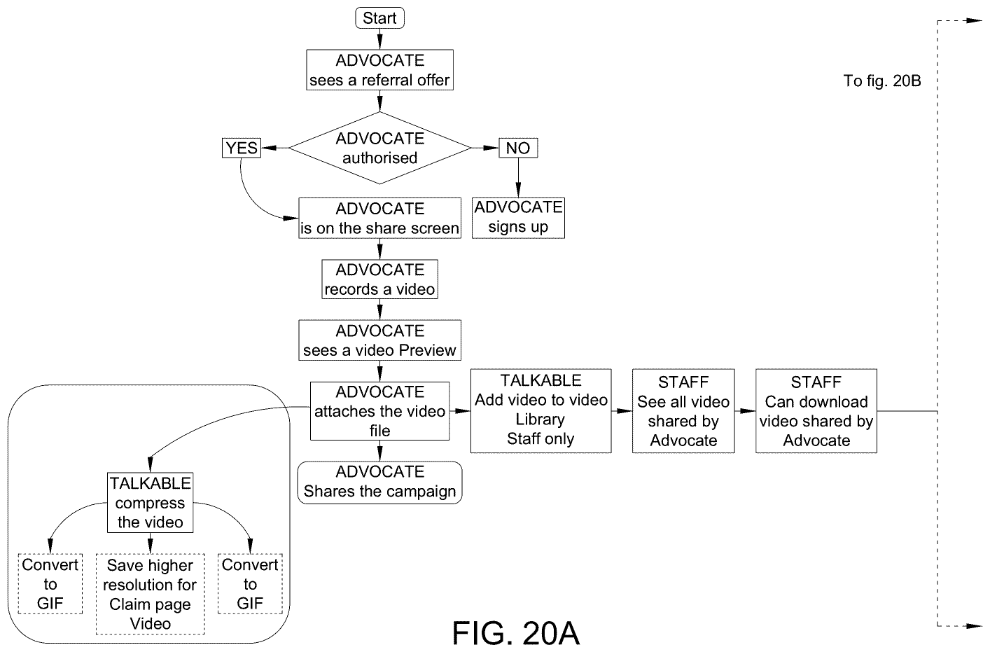

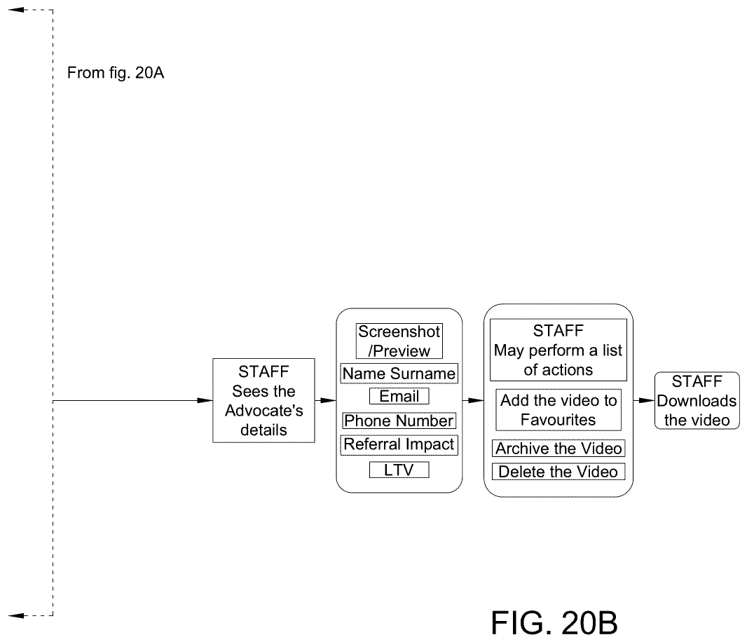

FIGS. 20A, and 20B is a flow chart of the user experience for the end user dashboard as taught by the present invention. The method starts when an Advocate sees a referral offer and is either authorized to share it or must sign up. If the Advocate is not signed up, they will proceed through a sign up process until they are authorized. Once authorized, the Advocate is on the share screen and records a video, sees a video preview, and can attach the video file and share before finally sharing the campaign.

Referring still to FIGS. 20A, and 20B, after the Advocate attaches the video file, the system compresses the video to save the video below 10 MB, creates and saves a higher resolution version for use as a claim page video, and converts the video to a three to five second animated GIF. The 10 MB threshold for saving a video is a constriction for iMessaging because of Apple's Open Graph Protocol.

The system further adds the video to a video library for staff use only Staff can see all videos created and shared by an Advocate and can download shared videos and see Advocate's details such as name/surname, email, phone, referral impact, purchase history, customer lifetime value (LTV) and the screenshot/preview. Staff may perform a list of actions, add videos to favorites, archive videos, and delete videos or download them.

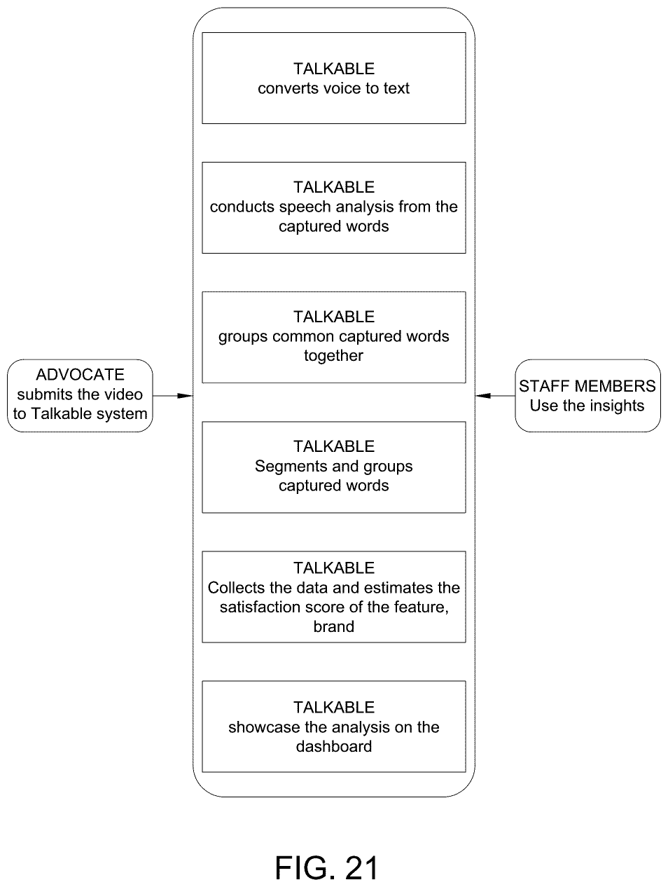

FIG. 21 is a flowchart diagram for voice to text transcribing and analysis as taught by the present invention. This process starts when an Advocate submits a video to the system. The system then converts the video to text, conducts speech analysis from the captured words, groups common captured words together, segments and groups captured words, collects the data and estimates the satisfaction score of the feature, brand, and finally showcases the analysis on the dashboard. The process ends by providing staff members with insights for use.

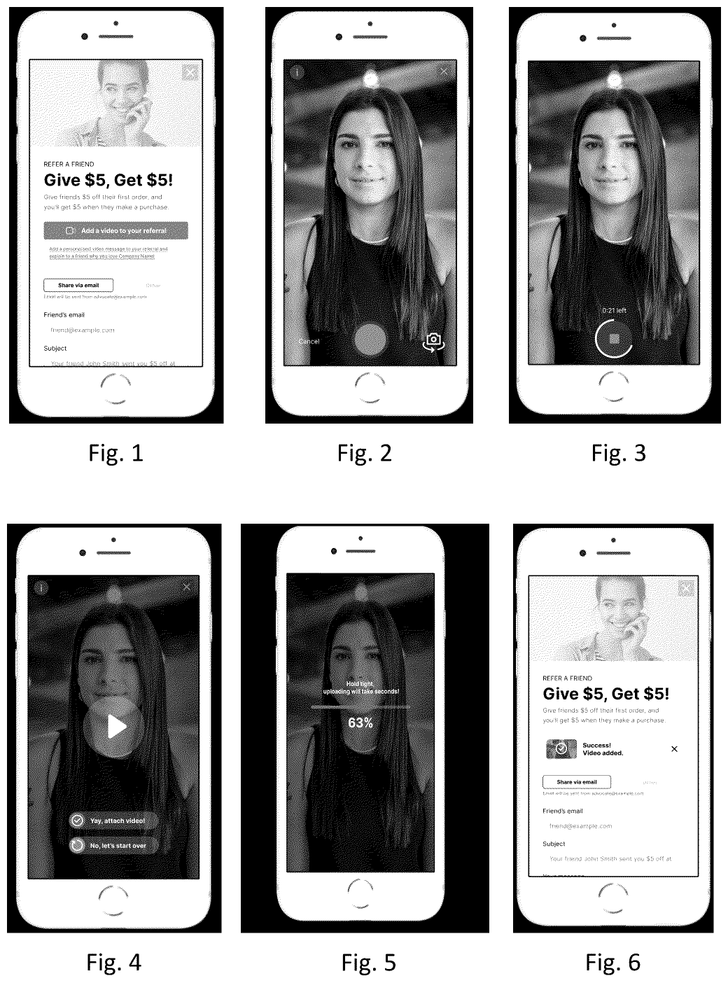

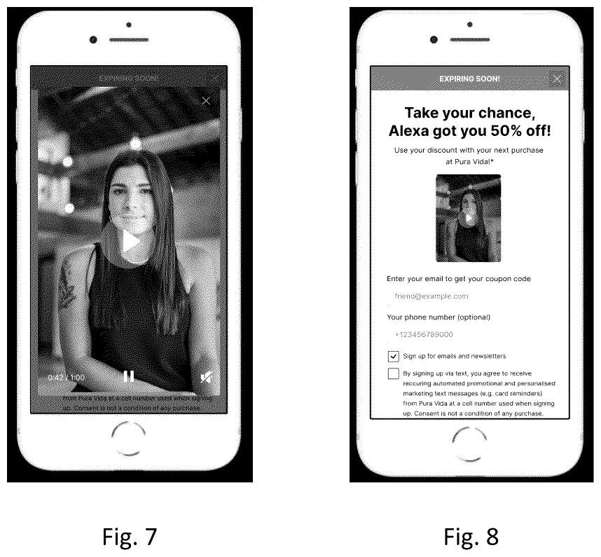

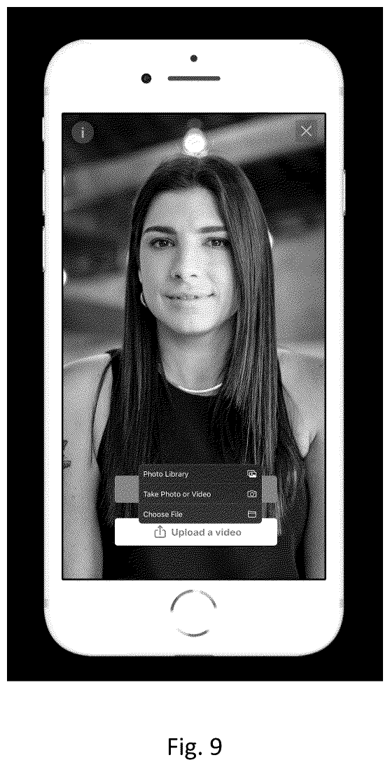

FIGS. 1-6 are illustrative screenshots of the user experience illustrating a first flow of the user experience and user interface for the referral sharing with video as taught by the present invention. FIGS. 7-8 are illustrative screenshots of the user experience illustrating a second flow of the user experience and user interface for the referral sharing with video as taught by the present invention. FIG. 9 is an illustrative screenshot of the user experience for uploading a previously created or recorded video for the referral sharing with video as taught by the present invention.

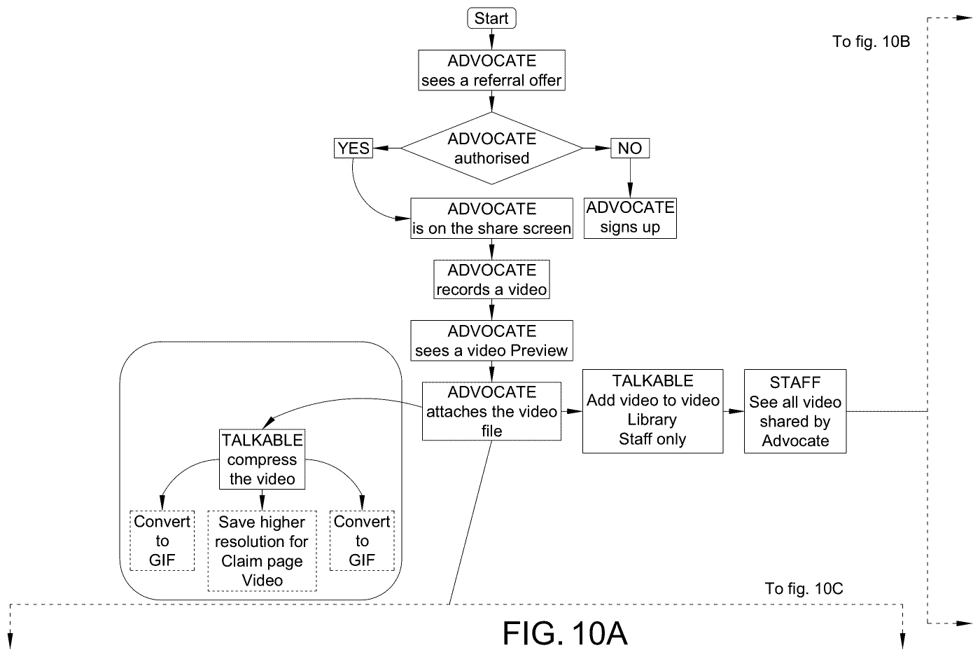

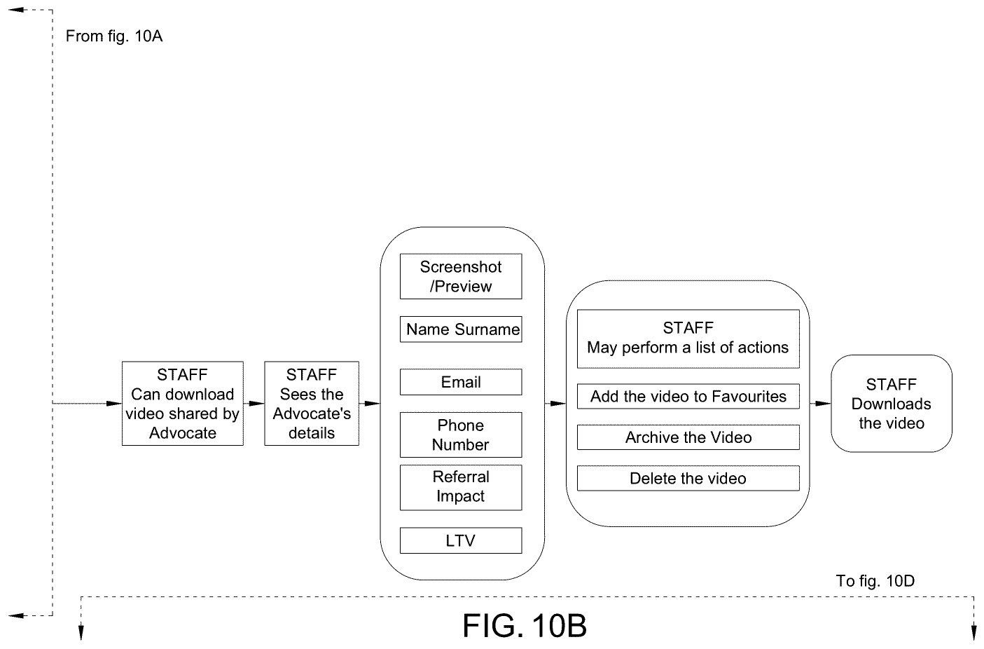

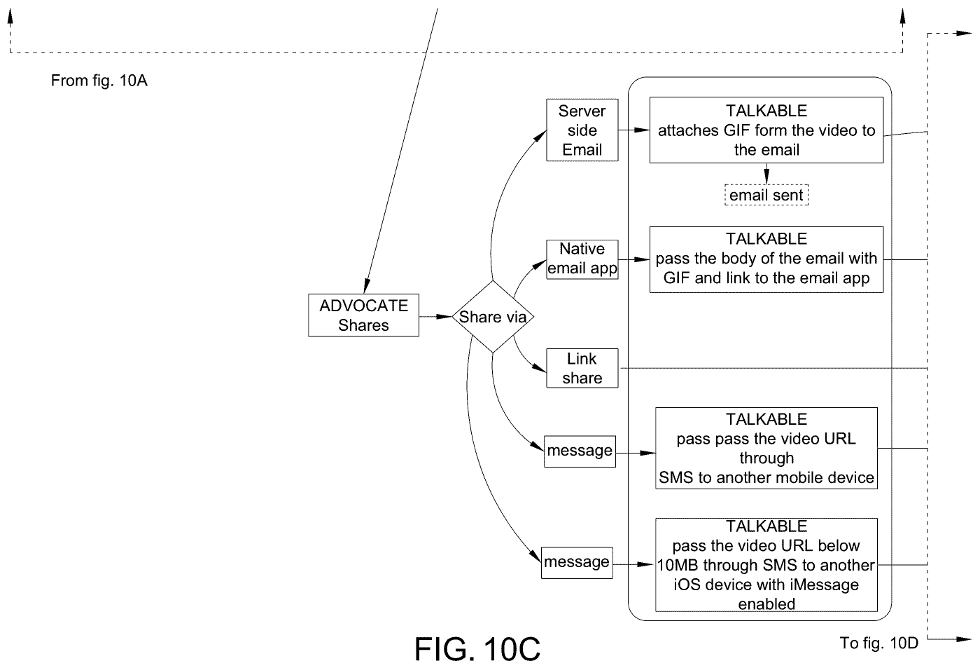

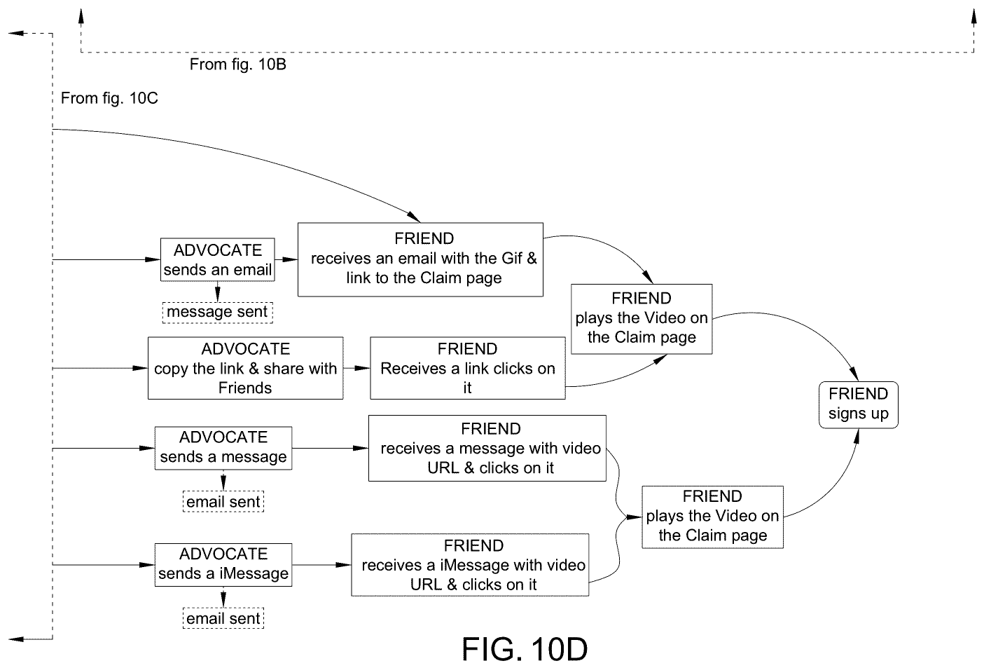

FIGS. 10A, 10B, 10C, and 10D is a master flow chart for the system and method specifically tailored for the inclusion and sharing of short-form video within referral marketing as taught by the present invention. The system starts when an Advocate sees the referral campaign as shown in FIG. 1. If the Advocate is not signed up or registered, the Advocate would go through a signup process. Once or if the Advocate is signed up and logged in, a share screen is displayed to the Advocate.

Next the Advocate is presented with a screen to record a video as shown in FIG. 2 and can proceed to record a video as shown in FIG. 3. The Advocate is able to record a video as shown in FIGS. 1-8 or attach a video as shown in FIG. 9. Video attachment happens by adding a video from advocate's mobile or desktop device.

Advocate recording is seamless on mobile or desktop devices. The Advocate is able to record up to 1 minute, replay the video, re-record video, and select the recorded video for usage in the referral campaign as shown in FIGS. 1-8.

Upon advocate's permission, video is attached to the referral campaign page as shown in FIG. 8. The Advocate is able to preview the video again as shown in FIG. 7 and the Advocate is able to delete the video.

Referring again to FIGS. 10A, 10B, 10C, and 10D, after the Advocate attaches the video file, the system compresses the video to save the video below 10 MB, creates and saves a higher resolution version for use as a claim page video, and converts the video to a three to five second animated GIF. The 10 MB threshold for saving a video is a constriction for iMessaging because of Apple's Open Graph Protocol.

The system further adds the video to a video library for staff use only. Staff can see all videos created and shared by an Advocate and can download shared videos and see Advocate's details such as name/surname, email, phone, referral impact, LTV, and the screenshot/preview. Staff may perform a list of actions, add videos to favorites, archive videos, and delete videos or download them.

Still referring to FIGS. 10A, 10B, 10C, and 10D, when an Advocate shares a video, it is shared by server side email, native email applications, link sharing, messaging, and iMessaging. For server side email, the system attaches three to five second animated GIFs from the video to the email, which is then sent to one or more friends who receive an email with the three to five second animated GIF and link to the claim page. The friend plays the video on the claim page and in some instances the friend signs up.

For native email applications, the system passes the body of the email with a three to five second animated GIF and link to the claim page. The advocate sends an email to one or more friends who receive an email with the three to five second animated GIF and link to the claim page. The friend plays the video on the claim page and in some instances the friend signs up.

For link sharing, the Advocate copies the link and shares it with friends. The friend receives the link and clicks on the URL in the animated GIF. The friend plays the video on the claim page and in some instances the friend signs up.

For messages, the system passes the animated GIF with a clickable URL to the video through SMS to another mobile device. The advocate sends a message, and the friend receives a message with the animated GIF with a clickable URL to the video and clicks on the URL in the animated GIF. The friend plays the video on the claims page and in some instances the friend signs up.

For iMessages, the system passes the animated GIF with a clickable URL to the video below 10 MB through SMS to another iOS device with iMessage enabled. The advocate sends an iMessage and the friend receives as iMessage with the animated GIF with a clickable URL to the video and clicks on the URL in the animated GIF. The friend plays the video on the claims page and in some instances the friend signs up. The 10 MB threshold for saving a video is a constriction for iMessaging because of Apple's Open Graph Protocol.

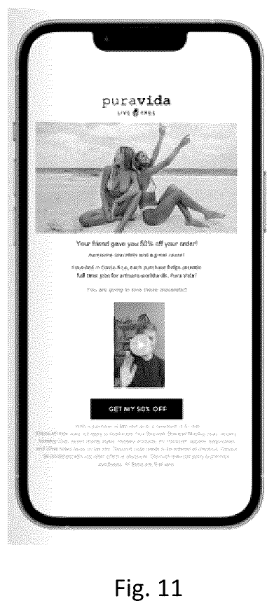

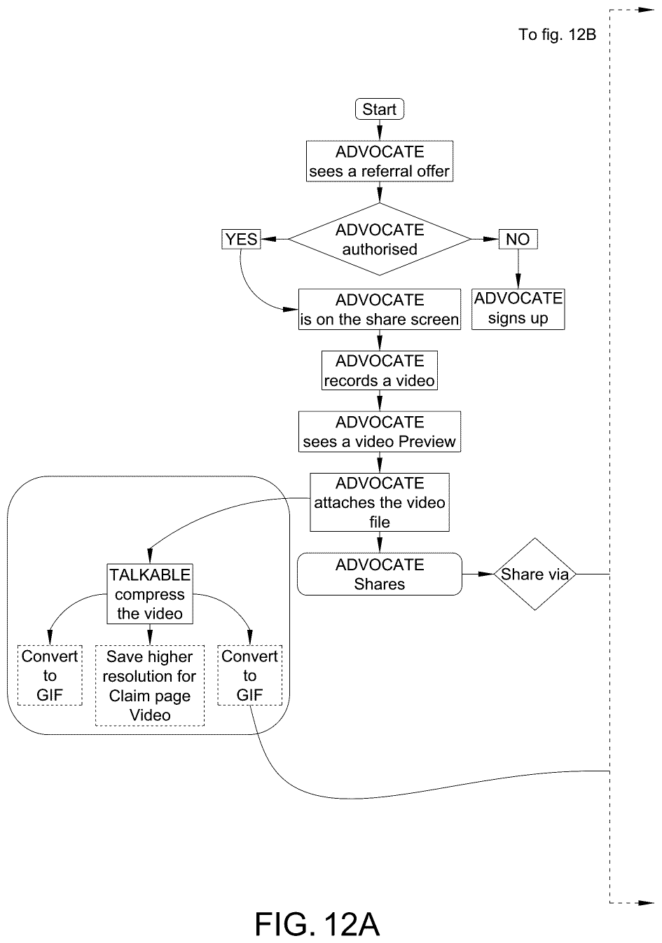

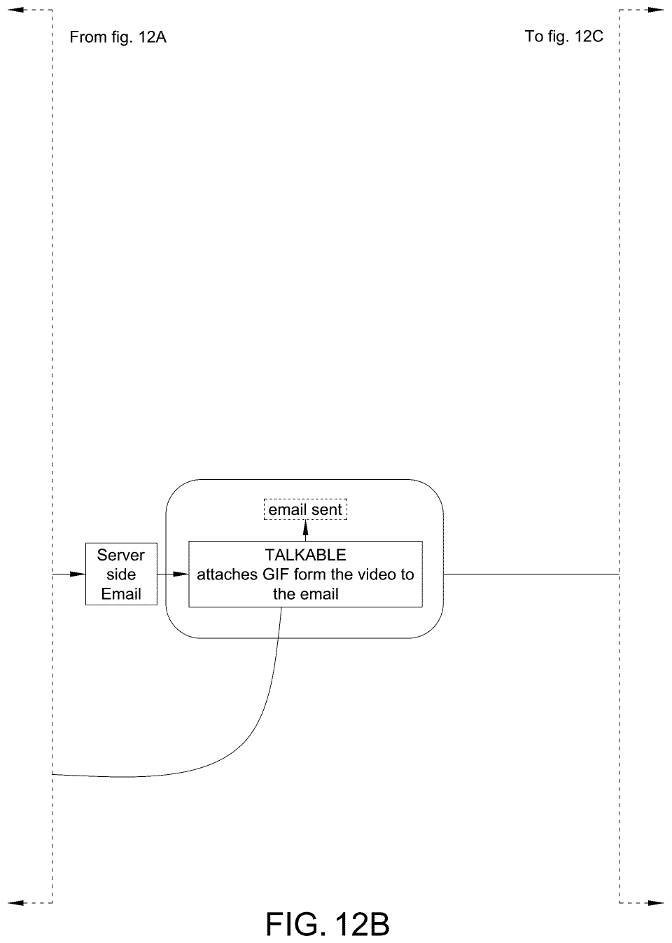

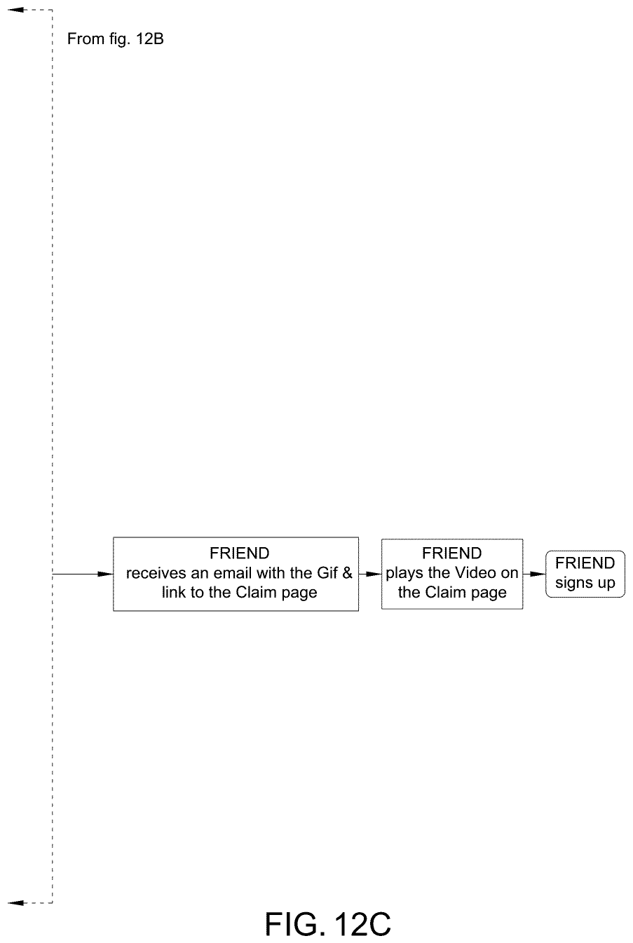

Now referring to FIG. 11 and FIGS. 12A, 12B, and 12C, Advocate referral sharing with short-form UGC video via email sharing is illustrated.

If the advocate chooses email as a sharing option, whether the email is server sent or natively shared, specific file format renderings of the video are required due to technical limitations of attaching a large video to an email, as well as email client renderings of video formats. To ensure full compatibility of the video rendering in email clients, a looping three to five second animated GIF of the video must be rendered and embedded into the email for a visual representation of the video.

For Server Side Email Sharing, an Advocate shares the referral offer as shown in FIG. 11 with the recorded video and includes all email addresses to which to share the offer. The original video is processed to include a looping three to five second animated GIF (first 5 seconds of the video) with an overlaid play icon on the three to five second animated GIF. The three to five second animated GIF of the video is embedded with the referral offer emails. Recipients who receive the email are able to click the offer in the email or click the looping three to five second animated GIF to see the full video recording on the claim page.

FIGS. 12A, 12B, and 12C is a flow chart of the user experience for server side email sharing with embedded three to five second animated GIF as taught by the present invention. The method starts when an Advocate sees a referral offer and is either authorized to share it or must sign up. If the Advocate is not signed up, they will proceed through a sign up process until they are authorized. Once authorized, the Advocate is on the share screen and records a video, sees a video preview, and can attach the video file and share.

Referring still to FIGS. 12A, 12B, and 12C, after the Advocate attaches the video file, the system compresses the video to save the video below 10 MB, creates and saves a higher resolution version for use as a claim page video, and converts the video to a three to five second animated GIF. The 10 MB threshold for saving a video is a constriction for iMessaging because of Apple's Open Graph Protocol.

In this embodiment, the system shares using server side email where the system attaches a three to five second animated GIF from the video to the email. A friend receives an email with the three to five second animated GIF and link to the claim page. The friend plays the video on the claim page and in some instances the friend will also sign up.

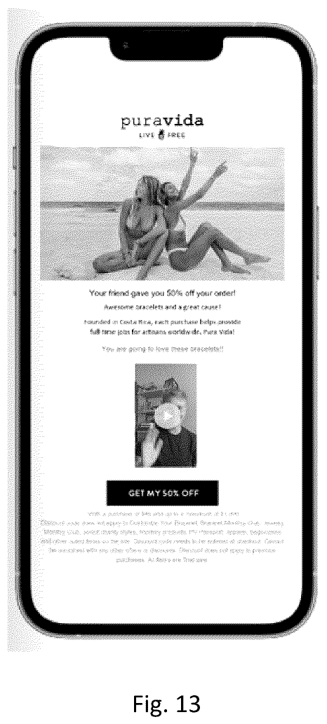

FIG. 13 is an illustrative screenshot of the user experience for native side email sharing with embedded three to five second animated GIF as taught by the present invention.

In Native Email Sharing, an Advocate shares the referral offer with the recorded video through a native email client to a recipient's email address. The original video is processed to include a looping three to five second animated GIF (first 5 seconds of the video) with an overlaid play icon on the three to five second animated GIF. The three to five second animated GIF is automatically embedded in the native email client and is hyperlinked. Recipients who receive the email are able to click the offer in the email or click the looping three to five second animated GIF to see the full video recording on the claim page.

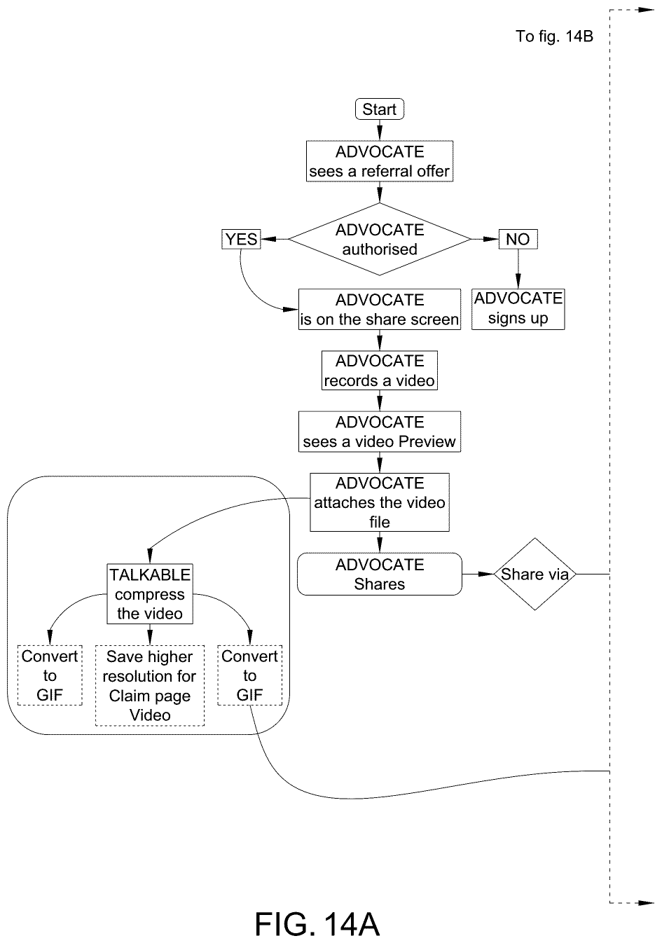

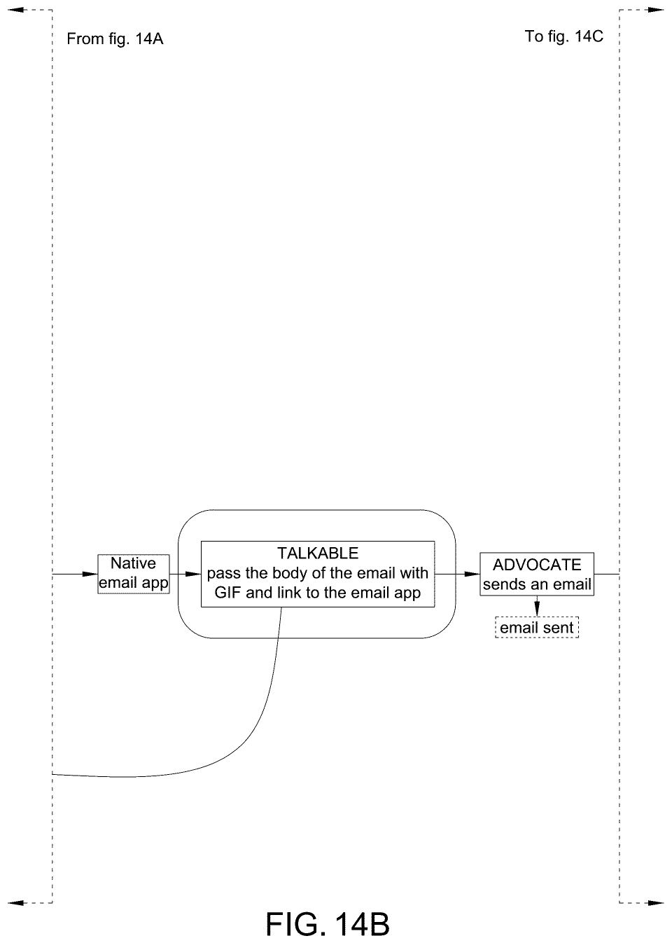

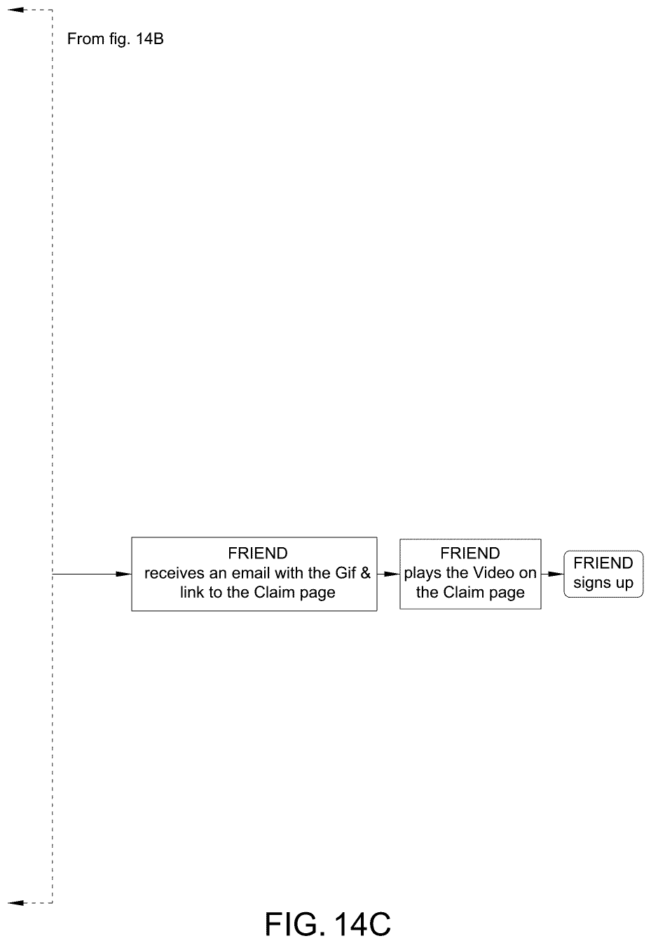

FIGS. 14A, 14B, and 14C is a flow chart of the user experience for native email sharing with an embedded three to five second animated GIF as taught by the present invention. The method starts when an Advocate sees a referral offer and is either authorized to share it or must sign up. If the Advocate is not signed up, they will proceed through a sign up process until they are authorized. Once authorized, the Advocate is on the share screen and records a video, sees a video preview, and can attach the video file and share.

Referring still to FIGS. 14A, 14B, and 14C, after the Advocate attaches the video file, the system compresses the video to save the video below 10 MB, creates and saves a higher resolution version for use as a claim page video, and converts the video to a three to five second animated GIF. The 10 MB threshold for saving a video is a constriction for iMessaging because of Apple's Open Graph Protocol.

In this embodiment, the system shares using native email where the system passes the body of the email with a three to five second animated GIF from the video and a link to the email in the application. The Advocate sends an email, a friend receives an email with the three to five second animated GIF and link to the claim page. The friend plays the video on the claim page and in some instances the friend will also sign up.

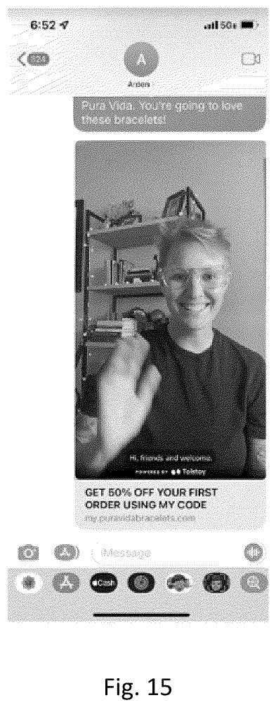

FIG. 15 is an illustrative screenshot demonstrating embedded video in an iMessage as taught by the present invention. If the advocate chooses SMS as a sharing option on their mobile device, specific file format renderings of the video are required due to technical limitations of iOS iMessage Messaging and standard SMS Messaging (e.g., Android Devices). To ensure full compatibility of the video rendering within an SMS thread, certain methods and processes must be met.

Due to support for “Rich Media” Link Previewing within iMessage the recorded video can be fully visible as part of the link. In order for the video to be rendered within Link Previewing, Open Graph Protocol Video Tagging must be utilized, and the video must be below 10 MB. The 10 MB threshold for saving a video is a constriction for iMessaging because of Apple's Open Graph Protocol.

Prior to the advocate sharing the referral offer through SMS, an Open Graph iOS compatible version of the video is created. On the server-side, a new version of the video is created that meets the resolution and file size requirements. The Advocate shares the referral offer with the recorded video through SMS to another iOS device with iMessage enabled. The Recipient is able to see the full video and link within the SMS iMessage thread. The Recipient is able to click the link preview to see the full video recording on the claim page. The link URL includes meta data following the guidelines of the Open Graph Protocol, to maximize the chance the video is shown through the medium it is being shared on (e.g. WHAT'S APP, FACEBOOK MESSENGER).

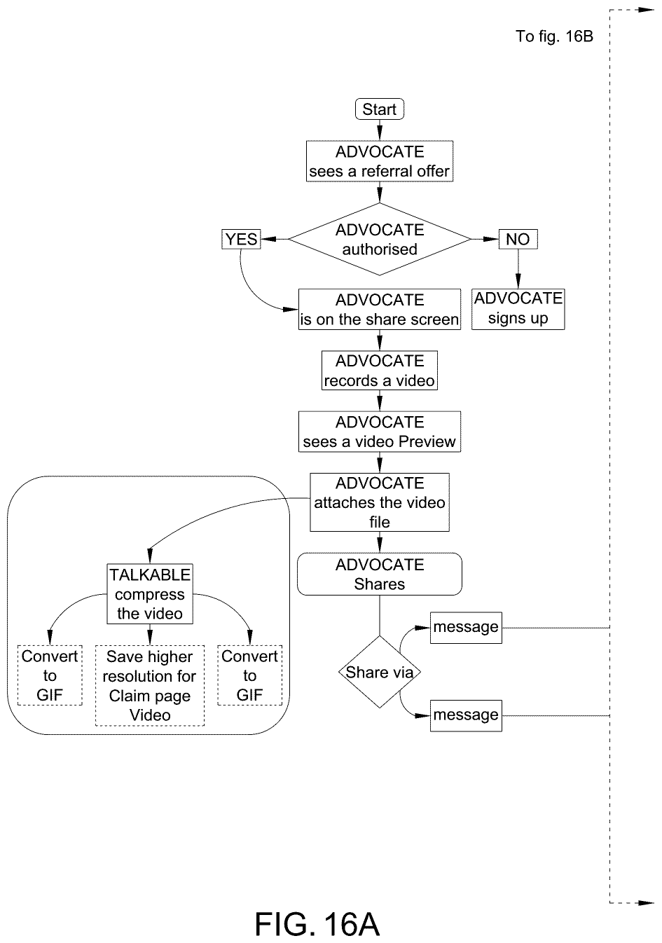

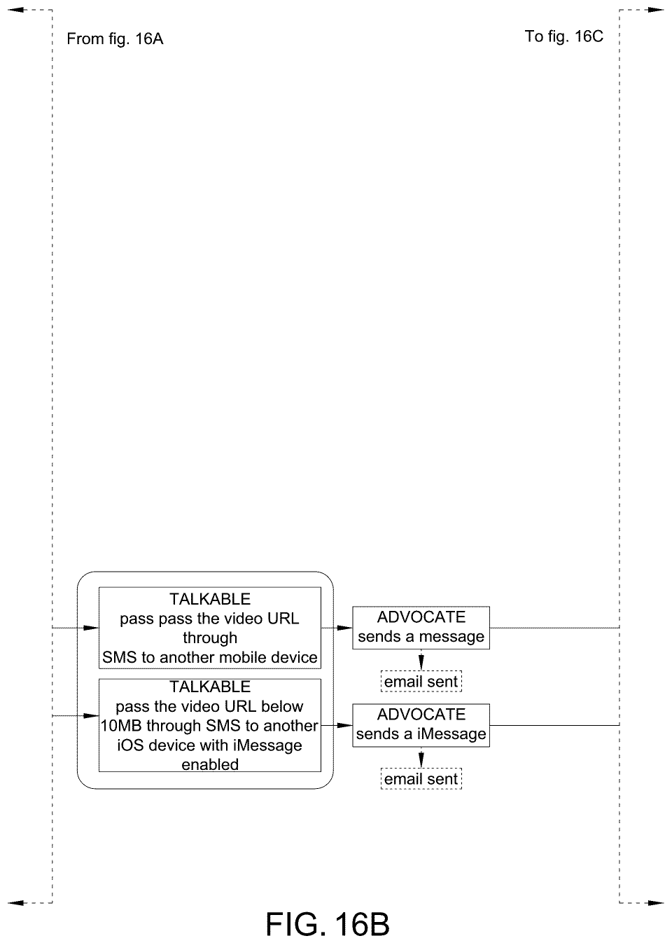

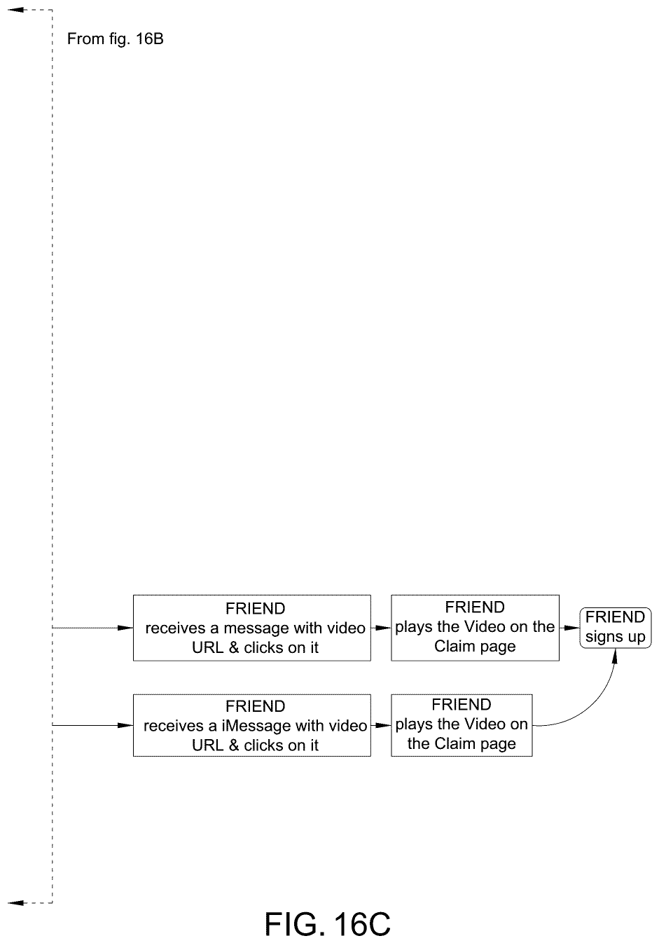

FIGS. 16A, 16B, and 16C is a flow chart for the method of creating embedded video in an iMessage as taught by the present invention. The method starts when an Advocate sees a referral offer and is either authorized to share it or must sign up. If the Advocate is not signed up, they will proceed through a sign up process until they are authorized. Once authorized, the Advocate is on the share screen and records a video, sees a video preview, and can attach the video file and share.

Referring still to FIGS. 16A, 16B, and 16C, after the Advocate attaches the video file, the system compresses the video to save the video below 10 MB, creates and saves a higher resolution version for use as a claim page video, and converts the video to a three to five second animated GIF. The 10 MB threshold for saving a video is a constriction for iMessaging because of Apple's Open Graph Protocol.

In this embodiment, the system shares using either message or iMessage.

For message sharing, the system passes the animated GIF with a clickable URL to the video through SMS to another mobile device. The Advocate then sends a message, a friend receives the message with the animated GIF with a clickable URL to the video and clicks on the URL in the animated GIF. The friend plays the video on the claim page and in some instances the friend will also sign up.

For iMessage sharing, the system passes the animated GIF with a clickable URL to the video below 10 MB through SMS to another iOS device with iMessage enabled. The Advocate then sends an iMessage, a friend receives the iMessage with the animated GIF with a clickable URL to the video and clicks on the URL in the animated GIF. The friend plays the video on the claim page and in some instances the friend will also sign up.

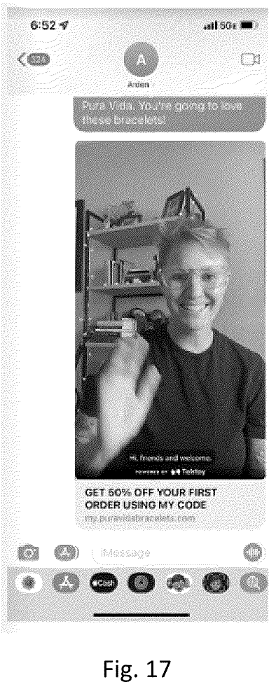

FIG. 17 is an illustrative screenshot demonstrating an embedded three to five second animated GIF file as taught by the present invention. For Standard SMS Messaging (e.g., ANDROID Devices), since “Rich Media” Link Previewing within standard SMS Messaging may not be supported, if the referrer is using a non-iOS device for SMS sharing, a different approach to iMessage must be utilized. Prior to the advocate sharing the referral offer through SMS, the original video is processed to include a looping three to five second animated GIF (first 3-5 seconds of the video). When an Advocate shares the referral offer through SMS and the three to five second animated GIF is attached to the text thread as an MMS or Link Preview. The Recipient is able to see the animated MMS/Link Preview in the text thread for contextual detail about a recorded video being part of the referral. The Recipient is able to click the link to see the full video recording on the claim page.

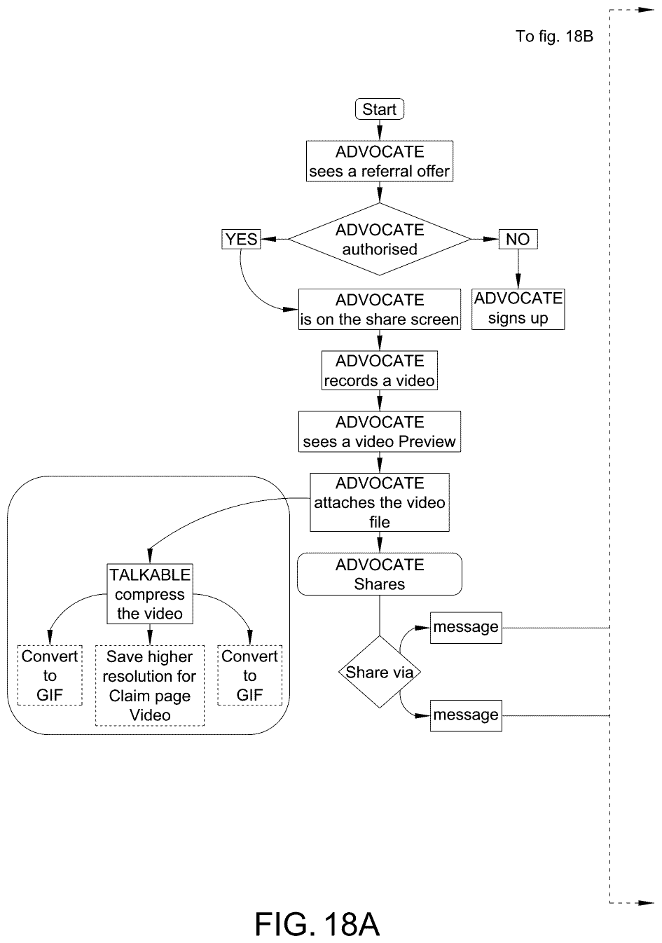

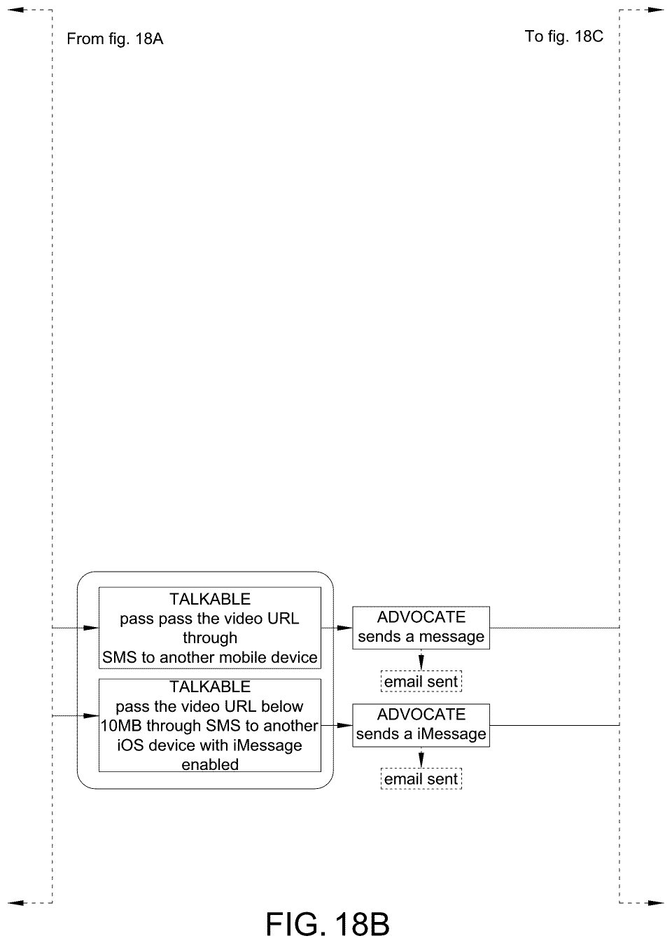

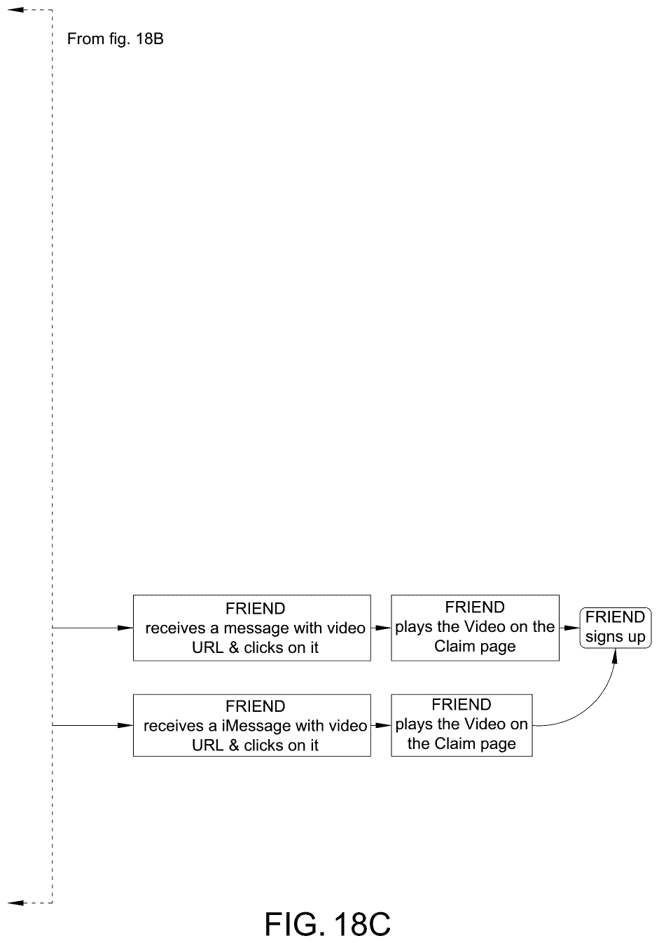

FIGS. 18A, 18B, and 18C is a flow chart for the method of creating an embedded three to five second animated GIF file as taught by the present invention. The method starts when an Advocate sees a referral offer and is either authorized to share it or must sign up. If the Advocate is not signed up, they will proceed through a sign up process until they are authorized.

Once authorized, the Advocate is on the share screen and records a video, sees a video preview, and can attach the video file and share.

Referring still to FIGS. 18A, 18B, and 18C, after the Advocate attaches the video file, the system compresses the video to save the video below 10 MB, creates and saves a higher resolution version for use as a claim page video, and converts the video to a three to five second animated GIF. The 10 MB threshold for saving a video is a constriction for iMessaging because of Apple's Open Graph Protocol.

In this embodiment, the system shares using either message or iMessage.

For message sharing, the system passes the animated GIF with a clickable URL to the video through SMS to another mobile device. The Advocate then sends a message to one or more friends, when a friend receives the message with the animated GIF with a clickable URL to the video and clicks on the URL in the animated GIF, the friend is taken to the URL link to the claim page where the video plays on the claim page. The friend plays the video on the claim page, as a result on clicking the URL in the animated GIF of the message, and in some instances the friend will also sign up.

For iMessage sharing, the system passes the animated GIF with a clickable URL to the video below 10 MB through SMS to another iOS device with iMessage enabled. The Advocate then sends an iMessage to one or more friends, when a friend receives the iMessage with the animated GIF with a clickable URL to the video and clicks on the URL in the animated GIF, the friend is taken to the URL link to the claim page where the video plays on the claim page. The friend plays the video on the claim page and in some instances the friend will also sign up. The 10 MB threshold for saving a video is a constriction for iMessaging because of Apple's Open Graph Protocol.

In an alternative embodiment, if the advocate chooses a social media platform for sharing purposes, such as Facebook, the video file will render utilizing the Open Graph Protocol or in a format supported by the social media platform. The Advocate shares the referral offer with the recorded video through a social media platform. The video and referral link will both be rendered on the selected social media platform.

In an alternative embodiment, if the advocate chooses the sharable link option, the video will be attaches to the sharable link utilizing all the best practices of the Open Graph Protocol. The link URL includes meta data following the guidelines of the Open Graph Protocol, to maximize the chance the video is shown through the medium it is being shared on (e.g. WHAT'S APP, FACEBOOK MESSENGER). This ensures maximum compatibility when using a sharable link.

The system is set to run on a computing device. A computing device on which the present invention can run would be comprised of a CPU, Hard Disk Drive, Keyboard, Monitor, CPU Main Memory and a portion of main memory where the system resides and executes. Any general-purpose computer with an appropriate amount of storage space is suitable for this purpose. Computer Devices like this are well known in the art and are not pertinent to the invention. The system can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A system and method specifically tailored for the inclusion and sharing of short-form video within referral marketing, executed by a machine, comprising:
presenting to an Advocate a referral campaign;
if the Advocate is not signed up or registered, the Advocate would go through a signup process;
once or if the Advocate is signed up and logged in, a share screen is displayed to the Advocate;
presenting the Advocate with a screen to record a video;
the Advocate is able to record a video or attach a video;
video attachment happens by adding a video from advocate's mobile or desktop device;
video is attached to the referral campaign page;
the Advocate is able to preview the video again; and
the Advocate is able to delete the video.

2. The method of claim 1, wherein
the Advocate is able to record up to 1 minute,
replay the video,
re-record video, and
select the recorded video for usage in the referral campaign.

3. The method of claim 1, wherein after the Advocate attaches the video file, the system
compresses the video to save the video below 10 MB,
creates and saves a higher resolution version for use as a claim page video, and
converts the video to a three to five second animated GIF.

4. The method of claim 1, wherein the system further adds the video to a video library for staff use only; staff can
see all videos created and shared by an Advocate;
download shared videos;
see Advocate's details such as name/surname, email, phone, referral impact, LTV, and the screenshot/preview; and
perform a list of actions,
add videos to favorites,
archive videos, and
delete videos or download them.

5. The method of claim 1, wherein when an Advocate shares a video, it is shared by
server side email,
native email applications,
link sharing,
messaging, and
iMessaging.

6. The method of claim 5, wherein for server side email,
the system attaches a three to five second animated GIFs from the video to the email, which is then sent to one or more friends who receive an email with the three to five second animated GIF and link to the claim page; and
the friend plays the video on the claim page and in some instances the friend signs up.

7. The method of claim 5, wherein for native email applications,
the system passes the body of the email with a three to five second animated GIF and link to the claim page;
the advocate sends an email to one or more friends who receive an email with the three to five second animated GIF and link to the claim page; and
the friend plays the video on the claim page and in some instances the friend signs up.

8. The method of claim 5, wherein for link sharing,
the Advocate copies the link and shares it with friends;
the friend receives the link and clicks on the URL in the animated GIF; and
the friend plays the video on the claim page and in some instances the friend signs up.

9. The method of claim 5, wherein for messages,
the system passes the animated GIF with a clickable URL to the video through SMS to another mobile device;
the advocate sends a message;
the friend receives a message with the animated GIF with a clickable URL to the video and clicks on the URL in the animated GIF; and
the friend plays the video on the claims page and in some instances the friend signs up.

10. The method of claim 5, wherein for iMessages,
the system passes the animated GIF with a clickable URL to the video below 10 MB through SMS to another iOS device with iMessage enabled;
the advocate sends an iMessage and the friend receives as iMessage with the animated GIF with a clickable URL to the video and clicks on the URL in the animated GIF; and
the friend plays the video on the claims page and in some instances the friend signs up.

11. The method of claim 5, wherein for advocate referral sharing with short-form UGC video via email sharing,
if the advocate chooses email as a sharing option, whether the email is server sent or natively shared, specific file format renderings of the video are required due to technical limitations of attaching a large video to an email, as well as email client renderings of video formats.

12. The method of claim 11, wherein
to ensure full compatibility of the video rendering in email clients, a looping three to five second animated GIF of the video must be rendered and embedded into the email for a visual representation of the video.

13. The method of claim 11, wherein for Server Side Email Sharing,
an Advocate shares the referral offer with the recorded video and includes all email addresses to share the offer to;
the original video is processed to include a looping three to five second animated GIF (first 3-5 seconds of the video) with an overlaid play icon on the three to five second animated GIF;
the three to five second animated GIF of the video is embedded with the referral offer emails; and
recipients who receive the email are able to click the offer in the email or click the looping three to five second animated GIF to see the full video recording on the claim page.

14. The method of claim 5, wherein for server side email sharing with embedded three to five second animated GIF, the method
starts when an Advocate sees a referral offer and is either authorized to share it or must sign up;
if the Advocate is not signed up, they will proceed through a sign up process until they are authorized;
once authorized, the Advocate is on the share screen and records a video, sees a video preview, and can attach the video file and share;
after the Advocate attaches the video file, the system compresses the video to save the video below 10 MB, creates and saves a higher resolution version for use as a claim page video, and converts the video to a three to five second animated GIF;
the system shares using server side email where the system attaches a three to five second animated GIF from the video to the email;
a friend receives an email with the three to five second animated GIF and link to the claim page; and
the friend plays the video on the claim page and in some instances the friend will also sign up.

15. The method of claim 5, wherein for native side email sharing with embedded three to five second animated GIF
an Advocate shares the referral offer with the recorded video through a native email client to a recipient's email address;
the original video is processed to include a looping three to five second animated GIF (first 3-5 seconds of the video) with an overlaid play icon on the three to five second animated GIF;
the three to five second animated GIF is automatically embedded in the native email client and is hyperlinked;
recipients who receive the email are able to click the offer in the email or click the looping three to five second animated GIF to see the full video recording on the claim page.

16. The method of claim 5, wherein for native email sharing with embedded three to five second animated GIF
when an Advocate sees a referral offer and is either authorized to share it or must sign up;
if the Advocate is not signed up, they will proceed through a sign up process until they are authorized;
once authorized, the Advocate is on the share screen and records a video, sees a video preview, and can attach the video file and share;
after the Advocate attaches the video file, the system compresses the video to save the video below 10 MB, creates and saves a higher resolution version for use as a claim page video, and converts the video to a three to five second animated GIF;
the system shares using native email where the system passes the body of the email with a three to five second animated GIF from the video and a link to the email in the application;
the Advocate sends an email,
a friend receives an email with the three to five second animated GIF and link to the claim page; and
the friend plays the video on the claim page and in some instances the friend will also sign up.

17. The method of claim 5, wherein if the advocate chooses SMS as a sharing option on their mobile device, specific file format renderings of the video are required due to technical limitations of iOS iMessage Messaging and standard SMS Messaging.

18. The method of claim 17, wherein
in order for the video to render within Link Previewing, Open Graph Protocol Video Tagging must be utilized, and the video must be below 10 MB;
prior to the advocate sharing the referral offer through SMS, an Open Graph iOS compatible version of the video is created;
on the server-side, a new version of the video is created that meets the resolution and file size requirements;
the Advocate shares the referral offer with the recorded video through SMS to another iOS device with iMessage enabled;
the Recipient is able to see the full video and link within the SMS iMessage thread; and
the Recipient is able to click the link preview to see the full video recording on the claim page.

19. The method of claim 5, wherein for the method of creating embedded video in an iMessage the method starts when an Advocate sees a referral offer and is either authorized to share it or must sign up;
if the Advocate is not signed up, they will proceed through a sign up process until they are authorized;
once authorized, the Advocate is on the share screen and records a video, sees a video preview, and can attach the video file and share;
after the Advocate attaches the video file,
the system compresses the video to save the video below 10 MB,
creates and saves a higher resolution version for use as a claim page video, and
converts the video to a three to five second animated GIF; and
in this embodiment, the system shares using either message or iMessage.

20. The method of claim 19, wherein for message sharing,
the system passes the animated GIF with a clickable URL to the video through SMS to another mobile device;
the Advocate then sends a message,
a friend receives the message with the animated GIF with a clickable URL to the video and clicks on the URL in the animated GIF; and
the friend plays the video on the claim page and in some instances the friend will also sign up.

21. The method of claim 19, wherein for iMessage sharing,
the system passes the animated GIF with a clickable URL to the video below 10 MB through SMS to another iOS device with iMessage enabled;
the Advocate then sends an iMessage,
a friend receives the iMessage with the animated GIF with a clickable URL to the video and clicks on the URL in the animated GIF; and
the friend plays the video on the claim page and in some instances the friend will also sign up.

22. The method of claim 21, wherein for Standard SMS, if the referrer is using a non-iOS device for SMS sharing, a different approach to iMessage must be utilized,
prior to the advocate sharing the referral offer through SMS, the original video is processed to include a looping three to five second animated GIF (first 3-5 seconds of the video);
when an Advocate shares the referral offer through SMS and the three to five second animated GIF is attached to the text thread as an MMS or Link Preview;
the Recipient is able to see the animated MMS/Link Preview in the text thread for contextual detail about a recorded video being part of the referral; and
the Recipient is able to click the link to see the full video recording on the claim page.

23. The method of claim 1, wherein
if the advocate chooses a social media platform for sharing purposes, the video file will render utilizing the Open Graph Protocol or in a format supported by the social media platform;
the Advocate shares the referral offer with the recorded video through a social media platform; and
the video and referral link will both be rendered on the selected social media platform.

24. The method of claim 1, wherein
if the advocate chooses the sharable link option, the video will be attaches to the sharable link utilizing all the best practices of the Open Graph Protocol.

25. The method of claim 1, further comprising the steps for voice to text transcribing and analysis
this process starts when an Advocate submits a video to the system;
the system then
converts the video to text,
conducts speech analysis from the captured words, groups common captured words together, segments and groups captured words,
collects the data and estimates the satisfaction score of the feature, brand, and finally showcases the analysis on the dashboard.
